(19) United States
(12) Patent Application Publication
(10) Pub. No.: US 2025/0348855 A1
(43) Pub. Date: Nov. 13, 2025

(54) FRAUD ELIMINATION IN INSTANT PAYMENT PROCESSING

(71) Applicant: Ionia, Inc., Gilbert, AZ (US)

(72) Inventors: Marshall Robert Greenwald, Queen Creek, AZ (US); John Laurell, Cypress, TX (US)

(73) Assignee: Ionia, Inc., Gilbert, AZ (US)

(21) Appl. No.: 19/201,064

(22) Filed: May 7, 2025

Related U.S. Application Data
(60) Provisional application No. 63/643,768, filed on May 7, 2024.

(51) Int. Cl. G06Q 20/10; G06Q 20/32; G06Q 20/40

(52) U.S. Cl. CPC G06Q 20/10; G06Q 20/322; G06Q 20/4014; G06Q 20/4016

(57) ABSTRACT

A computer-implemented method comprising receiving a payment request for a payment transaction from a consumer to a merchant using a payment account of the consumer. The method also can include at least one of evaluating fraud risk for the payment transaction based on an integration of (i) a verification that the consumer owns the payment account, and (ii) an authentication of the consumer and a verification of the payment request through a mobile device of the consumer; or processing the payment transaction using an FBO account to make funds from the payment transaction available to the merchant in an instant. Processing the payment transaction can include pulling funds from the payment account to the FBO account; and one of (i) transferring funds from a consumer ledger of the FBO account to a merchant ledger of the FBO account, and sending funds from the merchant ledger of the FBO account to a merchant account of the merchant, (ii) sending funds from the FBO account for consumers to a second FBO account for merchants, and sending funds from the second FBO account to a merchant account of the merchant; or (iii) sending funds from the FBO account to a DDA account for the merchant, and sending funds from the DDA account for the merchant to a merchant account of the merchant. Other embodiments are described.

### CROSS-REFERENCE TO RELATED APPLICATIONS

This application claims the benefit of U.S. Provisional Application No. 63/643,768, filed May 7, 2024, which is incorporated herein by reference in its entirety.

### TECHNICAL FIELD

This disclosure relates generally to fraud elimination in instant payment processing.

### BACKGROUND

Electronic payment systems have become increasingly prevalent in modern commerce, offering convenience and efficiency for both consumers and merchants. These systems facilitate transactions between parties, often involving the use of credit or debit cards, digital wallets, and other forms of electronic payment methods. Traditional payment processing typically involves multiple intermediaries, including payment gateways, acquiring banks, card networks, and issuing banks. This complex ecosystem can lead to delays in transaction settlement, increased costs due to multiple fees, and potential security vulnerabilities at various points in the payment chain.

### BRIEF DESCRIPTION OF THE DRAWINGS

FIG. 1 illustrates a front elevational view of a computer system that is suitable for implementing an embodiment of the system disclosed in FIG. 3;

FIG. 2 illustrates a representative block diagram of an example of the elements included in the circuit boards inside a chassis of the computer system of FIG. 1;

FIG. 3 illustrates a block diagram of a payment system that can be employed for fraud elimination in payment processing, according to an embodiment;

FIG. 4 illustrates a flow chart for a method of merchant onboarding for fraud elimination in payment processing, according to an embodiment;

FIG. 5A illustrates a flow chart for a method of consumer onboarding and payment processing for fraud elimination in payment processing;

FIG. 5B illustrate a flow chart for a method of existing user processing, according to an embodiment;

FIG. 6 illustrates a block diagram showing payment rails for payment processing using the payment system of FIG. 3, according to an embodiment; and

FIG. 7 illustrates a flow chart for a method of payment processing, according to an embodiment.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

As defined herein, “instant” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “instant” encompasses operations that occur in “near” instant or somewhat delayed from a triggering event. In a number of embodiments, “instant” can mean instant less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, five seconds, ten seconds, thirty seconds, one minute, five, ten minutes, thirty minutes, or one hour. For example, typical instant payment transactions using the techniques described herein can occur in third seconds or less, but delays in networks or third party services can result in additional delays in some cases.

### Description of Examples of Embodiments

Various embodiments can include a computer-implemented method including receiving a payment request for a payment transaction from a consumer to a merchant using a payment account of the consumer. The method also can include at least one of evaluating fraud risk for the payment transaction based on an integration of (i) a verification that the consumer owns the payment account, and (ii) an authentication of the consumer and a verification of the payment request through a mobile device of the consumer; or processing the payment transaction using an FBO account to make funds from the payment transaction available to the merchant in an instant. Processing the payment transaction can include pulling funds from the payment account to the FBO account; and one of (i) transferring funds from a consumer ledger of the FBO account to a merchant ledger of the FBO account, and sending funds from the merchant ledger of the FBO account to a merchant account of the merchant, (ii) sending funds from the FBO account for consumers to a second FBO account for merchants, and sending funds from the second FBO account to a merchant account of the merchant; or (iii) sending funds from the FBO account to a DDA account for the merchant, and sending funds from the DDA account for the merchant to a merchant account of the merchant.

Additional embodiments can include a system including one or more processors and one or more non-transitory computer-readable media storing computing instructions that, when executed on the one or more processors, cause the one or more processors to perform certain operations. The operations can include receiving a payment request for a payment transaction from a consumer to a merchant using a payment account of the consumer. The operations also can include at least one of evaluating fraud risk for the payment transaction based on an integration of (i) a verification that the consumer owns the payment account, and (ii) an authentication of the consumer and a verification of the payment request through a mobile device of the consumer; or processing the payment transaction using an FBO account to make funds from the payment transaction available to the merchant in an instant. Processing the payment transaction can include pulling funds from the payment account to the FBO account; and one of (i) transferring funds from a consumer ledger of the FBO account to a merchant ledger of the FBO account, and sending funds from the merchant ledger of the FBO account to a merchant account of the merchant, (ii) sending funds from the FBO account for consumers to a second FBO account for merchants, and sending funds from the second FBO account to a merchant account of the merchant; or (iii) sending funds from the FBO account to a DDA account for the merchant, and sending funds from the DDA account for the merchant to a merchant account of the merchant.

Additional embodiments can include one or more non-transitory computer-readable media comprising computing instructions that, when executed on one or more processors, cause one or more processors to perform certain operations. The operations can include receiving a payment request for a payment transaction from a consumer to a merchant using a payment account of the consumer. The operations also can include at least one of evaluating fraud risk for the payment transaction based on an integration of (i) a verification that the consumer owns the payment account, and (ii) an authentication of the consumer and a verification of the payment request through a mobile device of the consumer; or processing the payment transaction using an FBO account to make funds from the payment transaction available to the merchant in an instant. Processing the payment transaction can include pulling funds from the payment account to the FBO account; and one of (i) transferring funds from a consumer ledger of the FBO account to a merchant ledger of the FBO account, and sending funds from the merchant ledger of the FBO account to a merchant account of the merchant, (ii) sending funds from the FBO account for consumers to a second FBO account for merchants, and sending funds from the second FBO account to a merchant account of the merchant; or (iii) sending funds from the FBO account to a DDA account for the merchant, and sending funds from the DDA account for the merchant to a merchant account of the merchant.

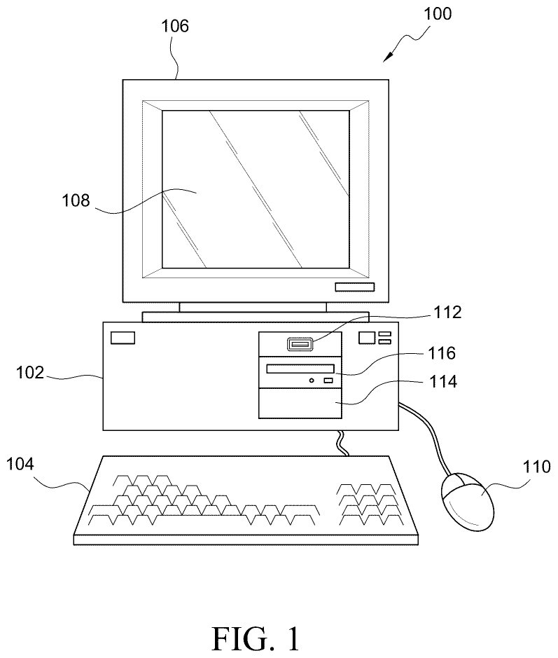

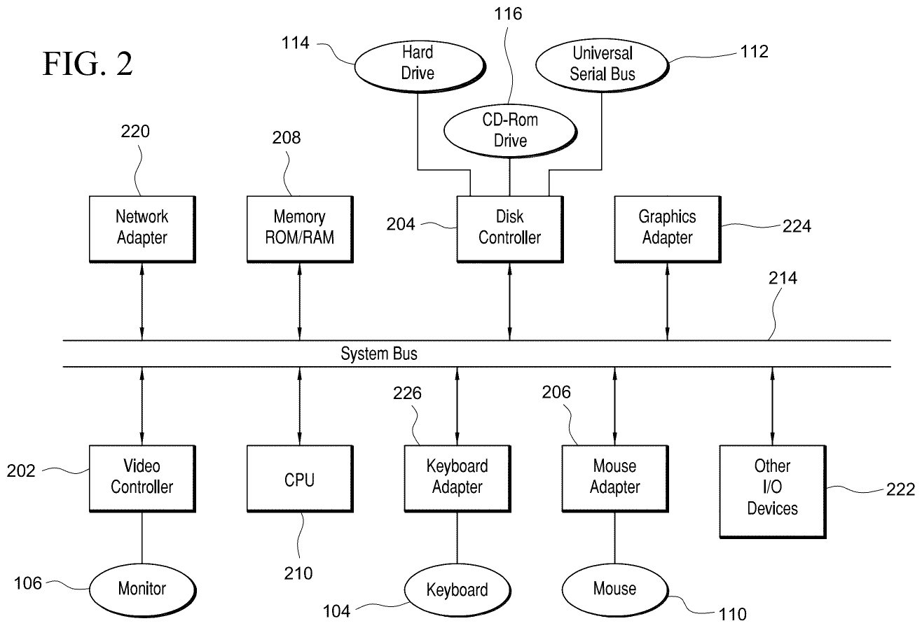

Turning to the drawings, FIG. 1 illustrates an exemplary embodiment of a computer system 100, all of which or a portion of which can be suitable for (i) implementing part or all of one or more embodiments of the techniques, methods, and systems and/or (ii) implementing and/or operating part or all of one or more embodiments of the non-transitory computer readable media described herein. As an example, a different or separate one of computer system 100 (and its internal components, or one or more elements of computer system 100) can be suitable for implementing part or all of the techniques described herein. Computer system 100 can comprise chassis 102 containing one or more circuit boards (not shown), a Universal Serial Bus (USB) port 112, a Compact Disc Read-Only Memory (CD-ROM) and/or Digital Video Disc (DVD) drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to memory storage unit 208 that includes both read only memory (ROM) and random access memory (RAM). Non-volatile portions of memory storage unit 208 or the ROM can be encoded with a boot code sequence suitable for restoring computer system 100 (FIG. 1) to a functional state after a system reset. In addition, memory storage unit 208 can include microcode such as a Basic Input-Output System (BIOS). In some examples, the one or more memory storage units of the various embodiments disclosed herein can include memory storage unit 208, a USB-equipped electronic device (e.g., an external memory storage unit (not shown) coupled to universal serial bus (USB) port 112 (FIGS. 1-2)), hard drive 114 (FIGS. 1-2), and/or CD-ROM, DVD, Blu-Ray, or other suitable media, such as media configured to be used in CD-ROM and/or DVD drive 116 (FIGS. 1-2). Non-volatile or non-transitory memory storage unit(s) refer to the portions of the memory storage units(s) that are non-volatile memory and not a transitory signal. In the same or different examples, the one or more memory storage units of the various embodiments disclosed herein can include an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Exemplary operating systems can include one or more of the following: (i) Microsoft® Windows® operating system (OS) by Microsoft Corp. of Redmond, Washington, United States of America, (ii) Mac® OS X by Apple Inc. of Cupertino, California, United States of America, (iii) UNIX® OS, and (iv) Linux® OS. Further exemplary operating systems can comprise one of the following: (i) the iOS® operating system by Apple Inc. of Cupertino, California, United States of America, (ii) the WebOS operating system by LG Electronics of Seoul, South Korea, (iii) the Android™ operating system developed by Google, of Mountain View, California, United States of America, or (iv) the Windows Mobile™ operating system by Microsoft Corp. of Redmond, Washington, United States of America.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 210.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to a keyboard 104 (FIGS. 1-2) and a mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for refreshing a monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM and/or DVD drive 116 (FIGS. 1-2). In other embodiments, distinct units can be used to control each of these devices separately.

In some embodiments, network adapter 220 can comprise and/or be implemented as a WNIC (wireless network interface controller) card (not shown) plugged or coupled to an expansion port (not shown) in computer system 100 (FIG. 1). In other embodiments, the WNIC card can be a wireless network card built into computer system 100 (FIG. 1). A wireless network adapter can be built into computer system 100 (FIG. 1) by having wireless communication capabilities integrated into the motherboard chipset (not shown), or implemented via one or more dedicated wireless communication chips (not shown), connected through a PCI (peripheral component interconnector) or a PCI express bus of computer system 100 (FIG. 1) or USB port 112 (FIG. 1). In other embodiments, network adapter 220 can comprise and/or be implemented as a wired network interface controller card (not shown).

Although many other components of computer system 100 (FIG. 1) are not shown, such components and their interconnection are well known to those of ordinary skill in the art. Accordingly, further details concerning the construction and composition of computer system 100 (FIG. 1) and the circuit boards inside chassis 102 (FIG. 1) are not discussed herein.

When computer system 100 in FIG. 1 is running, program instructions stored on a USB drive in USB port 112, on a CD-ROM or DVD in CD-ROM and/or DVD drive 116, on hard drive 114, or in memory storage unit 208 (FIG. 2) are executed by CPU 210 (FIG. 2). A portion of the program instructions, stored on these devices, can be suitable for carrying out all or at least part of the techniques described herein. In various embodiments, computer system 100 can be reprogrammed with one or more modules, system, applications, and/or databases, such as those described herein, to convert a general purpose computer to a special purpose computer. For purposes of illustration, programs and other executable program components are shown herein as discrete systems, although it is understood that such programs and components may reside at various times in different storage components of computer system 100, and can be executed by CPU 210. Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs.

Although computer system 100 is illustrated as a desktop computer in FIG. 1, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile device, such as a smartphone. In certain additional embodiments, computer system 100 may comprise an embedded system.

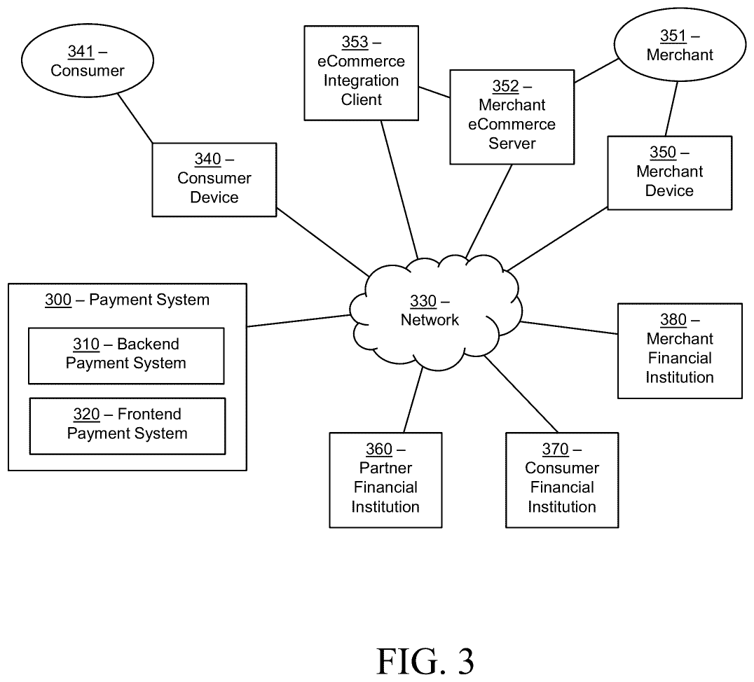

Turning ahead in the drawings, FIG. 3 illustrates a block diagram of a payment system 300 that can be employed for fraud elimination in payment processing, according to an embodiment. Payment system 300 is merely exemplary, and embodiments of the system are not limited to the embodiments presented herein. The payment system can be employed in many different embodiments or examples not specifically depicted or described herein. In some embodiments, certain elements, modules, or systems of payment system 300 can perform various procedures, processes, and/or activities. In other embodiments, the procedures, processes, and/or activities can be performed by other suitable elements, modules, or systems of payment system 300. In some embodiments, payment system 300 can include a backend payment system 310 and/or a frontend payment system 320. Generally, payment system 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of payment system 300 described herein.

In some embodiments, backend payment system 310 and/or frontend payment system 320 can each be a computer system, such as computer system 100 (FIG. 1), as described above, and can each be a single computer, a single server, or a cluster or collection of computers or servers, or a cloud of computers or servers. In another embodiment, a single computer system can host backend payment system 310 and/or frontend payment system 320. Additional details regarding backend payment system 310 and/or frontend payment system 320 are described herein.

In some embodiments, frontend payment system 320 can be in data communication through a network 330 with one or more other systems or devices, such as consumer devices (e.g., a consumer device 340) used by consumers (e.g., a consumer 341), merchant devices (e.g., a merchant device 350) used by merchants (e.g., a merchant 351), merchant eCommerce server (e.g., a merchant eCommerce server 352 of merchant 351), an eCommerce integration client 353, systems of one or more financial institution (e.g., a partner financial institution 360), and/or other suitable systems or devices. Additionally, consumers may hold accounts at consumer financial institutions (e.g., consumer 341 may hold an account at a consumer financial institution 370), and/or merchants may hold accounts at merchant financial institutions (e.g., merchant 351 may hold an account at a merchant financial institution 380), and there can be computing systems associated with each such financial institution. Network 330 can be the Internet or one or more other suitable networks. In many embodiments, frontend payment system 320 can host one or more websites and/or mobile application servers, which can be used to interface with payment system 300. For example, frontend payment system 320 can host a website, or provide a server that interfaces with an application (e.g., a mobile application), that can be used on consumer device 340 and/or merchant device 350, which can allow users (e.g., consumer 341, merchant 351) to interface with backend payment system 310, such as to enroll in and/or request instant payment transactions.

In some embodiments, an internal network that is not open to the public can be used for communications between backend payment system 310 and frontend payment system 320 within payment system 300. Accordingly, in some embodiments, backend payment system 310 (and/or the software used by such systems) can refer to a back end of payment system 300 operated by an operator and/or administrator of payment system 300, and frontend payment system 320 (and/or the software used by such systems) can refer to a front end of payment system 300, as is can be accessed and/or used by one or more users (e.g., consumer 341, merchant 351). In these or other embodiments, the operator and/or administrator of payment system 300 can manage payment system 300, the processor(s) of payment system 300, and/or the memory storage unit(s) of payment system 300 using the input device(s) and/or display device(s) of payment system 300.

In certain embodiments, each of the devices or systems shown in FIG. 3, such as consumer device 340, merchant device 350,) used by merchants (e.g., a merchant 351), merchant eCommerce websites (e.g., a merchant eCommerce website hosted by merchant eCommerce server 352 of merchant 351), eCommerce integration client 353, partner financial institution 360, consumer financial institution 370, merchant financial institution 380, can be servers, desktop computers, laptop computers, mobile devices, and/or other endpoint devices. A mobile device can refer to a portable electronic device (e.g., an electronic device easily conveyable by hand by a person of average size) with the capability to present audio and/or visual data (e.g., text, images, videos, music, etc.). For example, a mobile device can include at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device, or another portable computer device with the capability to present audio and/or visual data (e.g., images, videos, music, etc.). Thus, in many examples, a mobile device can include a volume and/or weight sufficiently small as to permit the mobile device to be easily conveyable by hand. For examples, in some embodiments, a mobile device can occupy a volume of less than or equal to approximately 1790 cubic centimeters, 2434 cubic centimeters, 2876 cubic centimeters, 4056 cubic centimeters, and/or 5752 cubic centimeters. Further, in these embodiments, a mobile device can weigh less than or equal to 15.6 Newtons, 17.8 Newtons, 22.3 Newtons, 31.2 Newtons, and/or 44.5 Newtons.

Exemplary mobile devices can include (i) an iPod®, iPhone®, iTouch®, iPad®, MacBook® or similar product by Apple Inc. of Cupertino, California, United States of America, or (ii) a Galaxy™ or similar product by the Samsung Group of Samsung Town, Seoul, South Korea. Further, in the same or different embodiments, a mobile device can include an electronic device configured to implement one or more of (i) the iPhone® operating system by Apple Inc. of Cupertino, California, United States of America, (ii) the Android™ operating system developed by the Open Handset Alliance, or (iii) the Windows Mobile™ operating system by Microsoft Corp. of Redmond, Washington, United States of America.

In many embodiments, backend payment system 310 and/or frontend payment system 320 can each include one or more input devices (e.g., one or more keyboards, one or more keypads, one or more pointing devices such as a computer mouse or computer mice, one or more touchscreen displays, a microphone, etc.), and/or can each comprise one or more display devices (e.g., one or more monitors, one or more touch screen displays, projectors, etc.). In these or other embodiments, one or more of the input device(s) can be similar or identical to keyboard 104 (FIG. 1) and/or a mouse 110 (FIG. 1). Further, one or more of the display device(s) can be similar or identical to monitor 106 (FIG. 1) and/or screen 108 (FIG. 1). The input device(s) and the display device(s) can be coupled to backend payment system 310 and/or frontend payment system 320 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processor(s) and/or the memory storage unit(s). In some embodiments, the KVM switch also can be part of backend payment system 310 and/or frontend payment system 320. In a similar manner, the processors and/or the non-transitory computer-readable media can be local and/or remote to each other.

Meanwhile, in many embodiments, backend payment system 310 and/or frontend payment system 320 also can be configured to communicate with one or more databases. The one or more databases can store inputs, constraints, data structures, and/or outputs used in enrolling for and/or processing instant payment, and/or other suitable information, as described below in further detail. The one or more databases can be stored on one or more memory storage units (e.g., non-transitory computer readable media), which can be similar or identical to the one or more memory storage units (e.g., non-transitory computer readable media) described above with respect to computer system 100 (FIG. 1). Also, in some embodiments, for any particular database of the one or more databases, that particular database can be stored on a single memory storage unit, or the contents of that particular database can be spread across multiple ones of the memory storage units storing the one or more databases, depending on the size of the particular database and/or the storage capacity of the memory storage units.

The one or more databases can each include a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database, and IBM DB2 Database.

Meanwhile, backend payment system 310, frontend payment system 320, and/or the one or more databases can be implemented using any suitable manner of wired and/or wireless communication. Accordingly, payment system 300 can include any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can include Bluetooth, Zigbee, Wireless Universal Serial Bus (USB), Z-Wave, etc.; exemplary LAN and/or WAN protocol(s) can include Institute of Electrical and Electronic Engineers (IEEE) 802.3 (also known as Ethernet), IEEE 802.11 (also known as WiFi), etc.; and exemplary wireless cellular network protocol(s) can include Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware implemented can depend on the network topologies and/or protocols implemented, and vice versa. In many embodiments, exemplary communication hardware can include wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can include wireless communication hardware including, for example, one or more radio transceivers, one or more infrared transceivers, etc. Additional exemplary communication hardware can include one or more networking components (e.g., modulator-demodulator components, gateway components, etc.).

In many embodiments, various systems of backend payment system 310 can be modules of computing instructions (e.g., software modules) stored at non-transitory computer readable media that operate on one or more processors. These systems can perform one or more functions of backend payment system 310. In some embodiments, various systems of backend payment system 310 can be implemented in hardware.

In many embodiments, the financial institutions (e.g., 360, 370, 380) can be depository financial institutions, such as savings banks, credit unions, savings and loan associations, etc. Consumer 341 can hold a consumer account, such as a checking account, a debit account, a credit card account, a digital wallet account, or another account at consumer financial institution 370, and an issuer can issue a card associated with the consumer account to facilitate transactions over a card network, such as VISA, MasterCard, or another suitable card network.

Conventionally, a consumer could use a card (e.g., a credit card) at a merchant (e.g., in person or at an eCommerce website) to pay merchant through the card network. However, there are numerous drawbacks to using the payment rails of the card network. First, there is significant complexity, and typically there are many parties involved in moving funds through a card network from a consumer account at a consumer financial institution to a merchant account at merchant financial institution. When the consumer interacts with the merchant to make a payment using the card, the merchant uses a payment gateway to communicate with an acquirer and/or the merchant financial institution, which communicates with an acquirer processor who is connected to the card network. The acquirer processor connects (through the card network) with an issuer processor, who communicates with an issuer and/or consumer financial institution to determine if the funds are available to fund the payment. If so, the funds are held, and an authorization code is provided back through the payment gateway. To actually move the funds, the merchant typically sends a batch file from the payment gateway through their acquirer, through the card network, to the consumer financial institution, and the funds are sent through a clearinghouse (e.g., the Automated Clearing House (ACH)) to the merchant financial institution. The card network is administered by an association that sets the rules and pricing for use of the card network. The complexity in this process exists because of the disjointed nature of having many different financial institutions that do not communicate other than through the card network. Additional drawbacks to this approach include the high transaction fees (e.g., 3%) charged by the card networks, fraud chargebacks that are assessed against merchants for fraudulent transactions, delays of 2-3 business days for funding on the ACH funding rails, etc.

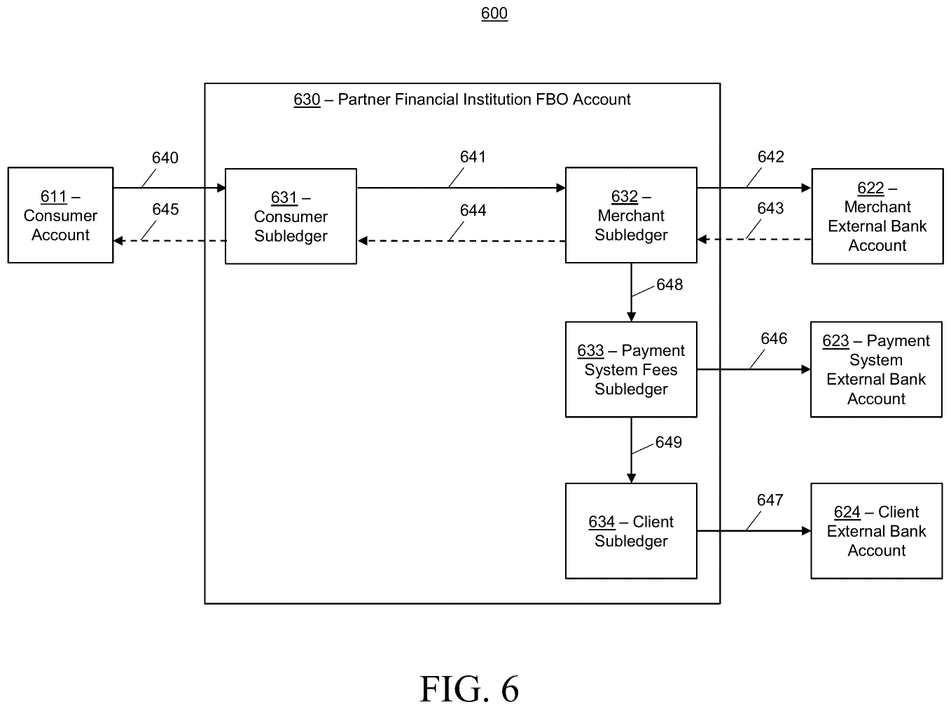

In a number of embodiments, the techniques provided by payment system 300 can beneficially eliminate and/or reduce the drawbacks described above. For example, the complexity of the conventional approach using card networks can be significantly reduced by using payment system 300. When a consumer (e.g., 341) tells the merchant (e.g., 351) it wants to make a payment using the consumer account (e.g., a payment account or a card associated with the payment account), such as in person at a point-of sale terminal or through a merchant eCommerce website hosted by merchant eCommerce server 352, merchant 351 can send a request from merchant device 350 to payment system 300, indicating that consumer 341 is wanting to make a payment to merchant 351. Payment system 300 can then send a message to consumer device 340 to ask consumer 341 (who has been confirmed to be the owner of the card) whether consumer 341 authorizes the payment to merchant 351. If consumer 341 confirms authorization of the transaction, the confirmation is sent back from consumer device 340 to payment system 300, which is forwarded to merchant device 350. Meanwhile, payment system 300 settles the funds in an instant using partner financial institution 360, as described below in further detail in connection with FIG. 6. The consumer has authorized and taken responsibility for funding the transaction, so there are no possible chargebacks against the merchant.

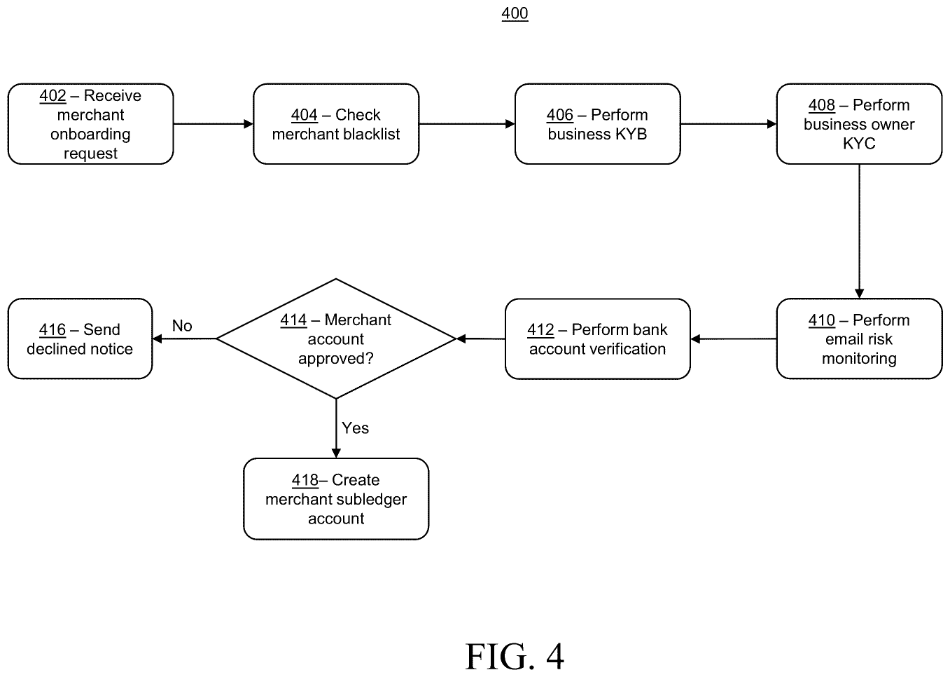

Turning ahead in the drawings, FIG. 4 illustrates a flow chart for a method 400 of merchant onboarding for fraud elimination in payment processing, according to an embodiment. Method 400 is merely exemplary and is not limited to the embodiments presented herein. Method 400 can be employed in many different embodiments or examples not specifically depicted or described herein. In some embodiments, the procedures, the processes, and/or the activities of method 400 can be performed in the order presented. In other embodiments, the procedures, the processes, and/or the activities of method 400 can be performed in any suitable order. In still other embodiments, one or more of the procedures, the processes, and/or the activities of method 400 can be combined or skipped.

In many embodiments, payment system 300 (FIG. 3), backend payment system 310 (FIG. 3), and/or frontend payment system 320 (FIG. 3) can be suitable to perform method 400 and/or one or more of the activities of method 400. In these or other embodiments, one or more of the activities of method 400 can be implemented as one or more computing instructions configured to run at one or more processors and configured to be stored at one or more non-transitory computer readable media. Such non-transitory computer readable media can be part of payment system 300 (FIG. 3). The processor(s) can be similar or identical to the processor(s) described above with respect to computer system 100 (FIG. 1). In some embodiments, method 400 and other activities in method 400 can include using a distributed network including distributed memory architecture to perform the associated activity. This distributed architecture can reduce the impact on the network and system resources to reduce congestion in bottlenecks while still allowing data to be accessible from a central location.

Referring to FIG. 4, method 400 can include an activity 402 of receiving a merchant onboarding request. In some embodiments, the merchant onboarding request can be received from the merchant (e.g., 351 (FIG. 3)), and in some embodiments, can come from an eCommerce platform marketplace. The onboarding request can be a request to create an account for the merchant to allow the merchant to receive payments using payment system 300 (FIG. 3). In some embodiments, the merchant onboarding request can be received by frontend payment system 320 (FIG. 3), which can provide an onboarding user interface. In some embodiments, the onboarding user interface can confirm whether the merchant wants to sign up for receiving payments through payment system 300 (FIG. 3), such as Ionia Pay, or another suitable payment solution that implements one or more of the techniques described herein. If confirmed, frontend payment system 320 (FIG. 3) can request further processing from backend payment system 310 (FIG. 3), such as the other activities of method 400 described below.

Next, method 400 can include an activity 404 of checking one or more merchant blacklists, if available, for the merchant request received in activity 402. For example, the merchant blacklist can be the MATCH list (formerly known as the Terminated Merchant File (TMF) list provided by MasterCard, which lists those merchants that have been terminated and/or blacklisted by MasterCard, such as for excessive chargebacks, security issues, illegal activity, bankruptcy, fraud, non-compliance, or other issues.

Next, method 400 can include an activity 406 of performing business KYB (Know Your Business) verification. For example, the KYB verification can include verification of business legitimacy for the merchant, identification and/or verification of the ownership structure and/or beneficial owners of the business, determining a risk profile of the business, anti-money laundering review, monitoring for suspicious transactions, checking the TIN (taxpayer identification number)/EIN (employer identification number), sanctions screening, and/or other suitable business verification. In some embodiments, activity 406 can request information and/or verification from one or more third party services.

Next, method 400 can include an activity 408 of performing business KYC (Know Your Client) verification. The KYC verification can involve verifying the merchant's identity and assessing risk. For example, the KYC verification can actively authenticate a mobile device of the merchant. In some embodiments, one or more of activities 408 involve requesting information and/or verification, and/or sanctions screening, from one or more third party services.

Next, method 400 can include an activity 410 of performing email risk monitoring. For example, activity 410 can involve verifying the merchant's identity and/or assessing risks associated with the merchant based on the merchant's provided email address. In some embodiments, activity 410 can request information and/or verification from one or more third party services. For example, a third party service can assess the age and risk of the merchant's email address.

Next, method 400 can include an activity 412 of performing bank account verification. For example, activity 412 can involve verifying the merchant's bank account, such as through automated approaches, where available. In some embodiments, activity 412 can request information and/or verification from one or more third party services.

Next, method 400 can include an activity 414 of determining whether to approve the creation of the merchant account. In many embodiments, this determination can be based on the results of the verifications performed in activities 404, 406, 408, 410, and/or 412. For example, in some examples, if any of these verifications are not successful, activity 412 can determine to not approve the creation of the merchant account, and if all of the verifications are successful, activity 414 can determine to approve the creation of the merchant account. If the outcome of activity 414 is no, method 400 can proceed to an activity 416 of sending a declined notice to the merchant, such as through the onboarding user interface and/or to the email account of the merchant. In some embodiments, method 400 can perform activities 404, 406, 408, 410, and/or 412, in any suitable order, until one of the verifications fail, after which the outcome of activity 414 can be no. If the outcome of activity 414 is yes, method 400 can proceed to an activity 418 of creating a merchant subledger account, such as a merchant subledger 632 (FIG. 6), as described below in further detail. Once the merchant subledger account is created, the merchant can be setup to process payments using payment system 300 (FIG. 3).

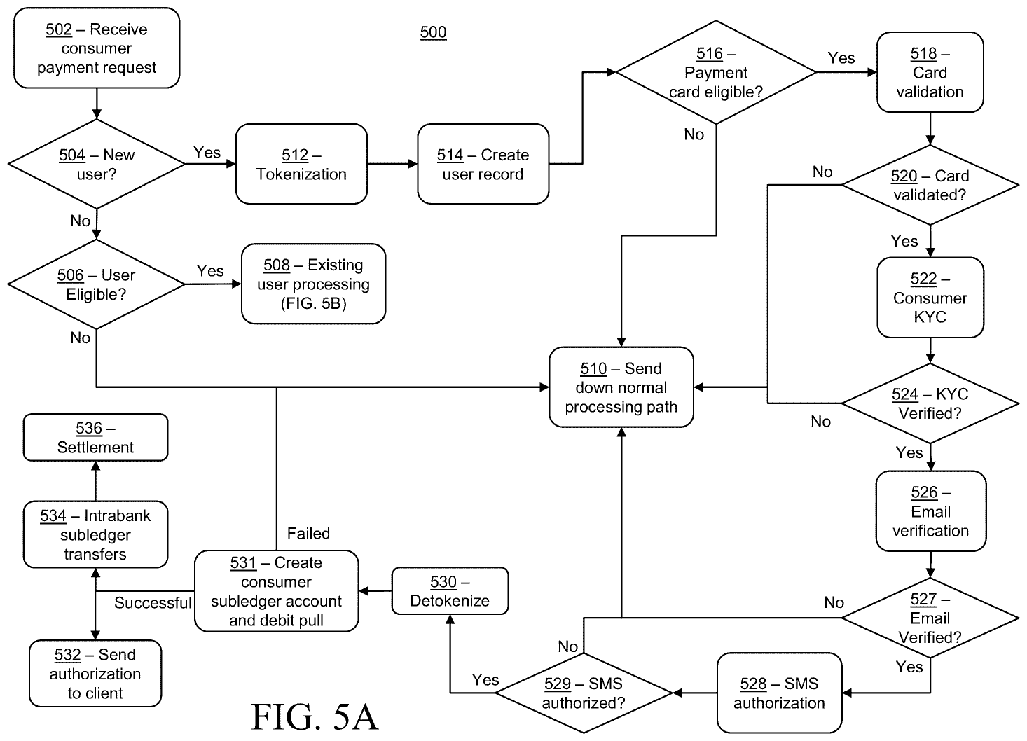

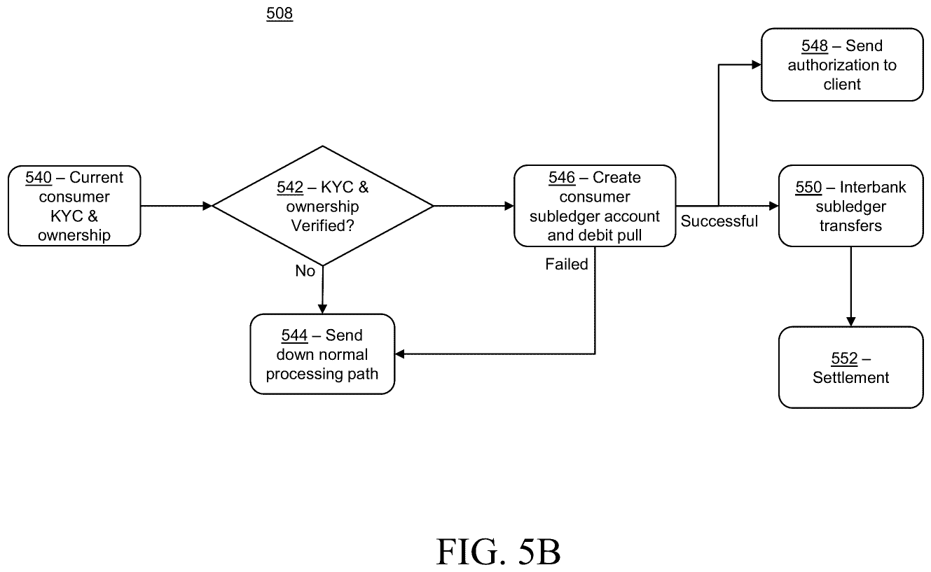

Turning ahead in the drawings, FIGS. 5A-5B illustrate a flow chart for a method 500 of consumer onboarding and payment processing for fraud elimination in payment processing, according to an embodiment. Method 500 is merely exemplary and is not limited to the embodiments presented herein. Method 500 can be employed in many different embodiments or examples not specifically depicted or described herein. In some embodiments, the procedures, the processes, and/or the activities of method 500 can be performed in the order presented. In other embodiments, the procedures, the processes, and/or the activities of method 500 can be performed in any suitable order. In still other embodiments, one or more of the procedures, the processes, and/or the activities of method 500 can be combined or skipped.

In many embodiments, payment system 300 (FIG. 3), backend payment system 310 (FIG. 3), and/or frontend payment system 320 (FIG. 3) can be suitable to perform method 500 and/or one or more of the activities of method 500. In these or other embodiments, one or more of the activities of method 500 can be implemented as one or more computing instructions configured to run at one or more processors and configured to be stored at one or more non-transitory computer readable media. Such non-transitory computer readable media can be part of payment system 300 (FIG. 3). The processor(s) can be similar or identical to the processor(s) described above with respect to computer system 100 (FIG. 1). In some embodiments, method 500 and other activities in method 500 can include using a distributed network including distributed memory architecture to perform the associated activity. This distributed architecture can reduce the impact on the network and system resources to reduce congestion in bottlenecks while still allowing data to be accessible from a central location.

Referring to FIG. 5A, method 500 can include an activity 502 of receiving a consumer onboarding/payment request. In some embodiments, the consumer onboarding/payment request can be received from the consumer (e.g., 341 (FIG. 3)), the merchant (e.g., 351 (FIG. 3)), an eCommerce integration client (e.g., 353 (FIG. 3)), and/or another suitable entity. For example, a shopping cart of a merchant eCommerce website hosted by a merchant eCommerce server (e.g., 352 (FIG. 3)) can be integrated with an eCommerce integration client (e.g., 353 (FIG. 3)), which can be provide integration with payment system 300 (FIG. 3). For example, the eCommerce integration client can be Open Path or another suitable service. The onboarding/payment request can be a request to make a payment from the consumer (e.g., 341 (FIG. 3)) to the merchant (e.g., 351 (FIG. 3)). In some embodiments, the consumer onboarding/payment request can be received by frontend payment system 320 (FIG. 3), which can provide an API for the eCommerce integration client (e.g., 353 (FIG. 3)), or can provide a user interface, such as to a consumer (e.g., 341 (FIG. 3)). In many embodiments, frontend payment system 320 (FIG. 3) can request further processing from backend payment system 310 (FIG. 3), such as the other activities of method 500 described below.

Next, method 500 can include an activity 504 of determining whether the consumer associated with the consumer onboarding/payment request is a new user for making payments through payment system 300 (FIG. 3). If the outcome of activity 504 is no (e.g., the consumer has previously used payment system 300 (FIG. 3)), method 500 can proceed to an activity 506 of determining if the user (e.g., consumer) is eligible for making payments through payment system 300 (FIG. 3). If the outcome of activity 506 is yes, method 500 can proceed to an activity 508 of existing user processing, as shown in FIG. 5B and described below in further detail. If the outcome of activity 506 is no, method 500 can proceed to an activity 510 of sending the payment processing down the normal processing path, such as using the conventional card network processing approach described above, instead of processing the payment through payment system 300 (FIG. 3).

If the outcome of activity 504 is yes, then the consumer is a new user for making payments through payment system 300 (FIG. 3), and the outcome can proceed to new user processing, as shown in activities 512-536, starting with an activity 512 of performing tokenization. The tokenization process can protect sensitive information, such as card information (e.g., card number, expiration date, CVV (card verification value), etc.), personal identifiable information (PII) (e.g., such as consumer full name, social security number, address, phone number, email address, etc.), and/or other suitable information, with tokens. In some embodiments, the tokenization can involve requesting tokens from one or more third party services. In a number of embodiments, a detokenization process (e.g., activity 530, described below) can be performed when sending information to other systems and/or third parties for processing.

Next, method 500 can proceed to an activity 514 of creating a user record for the consumer. In many embodiments, the tokens created in activity 512 can be used to store the information about the consumer in the user record. In some embodiments, the user record can be stored in a database in payment system 300 (FIG. 3).

Next, method 500 can proceed to an activity 516 of determining whether the payment card is eligible. For example, payment system 300 (FIG. 3) can support cards associated with certain card networks but not other card networks. If the outcome of the activity 516 is no (e.g., the payment card is not supported for making payments through payment system 300 (FIG. 3)), then method 500 can proceed to activity 510 of sending the payment processing down the normal processing path.

If the outcome of activity 516 is yes, then method 500 can proceed to an activity 518 of performing card validation. Activity 518 can include verifying the ownership of the payment card, which can be implemented in different ways depending on the type of card (e.g., the card network with which the card is associated). For example, for VISA cards, activity 518 can include performing VISA PAV (Payment Account Validation), ANI (Account Name Inquiry) to verify the address, CVV, and name of the card holder, and to use fuzzy/partial matching on the name, AVS (Address Verification Service) to verify that the address entered by the customer is actually associated with the cardholder's card account, performing account verification using a $0 authorization, and/or other suitable activities. For MasterCard cards, and/or cards failing VISA ANI, activity 518 can include requesting information and/or verification from one or more third party services. For example, a third party service can provide secure verification for cards.

Next, method 500 can proceed to an activity 520 of determining whether the card is validated, based on the information obtained in activity 518. If the outcome of activity 520 is no, method 500 can proceed to activity 510 of sending the payment processing down the normal processing path. If the outcome of activity 520 is yes, method 500 can proceed to an activity 522 of performing consumer KYC verification. The consumer KYC verification can involve verifying the consumer's identity and assessing risk. In many embodiments, the KYC verification can actively authenticate a mobile device of the consumer. For example, the mobile device authentication can verify ownership and possession of the mobile device and phone number, and a likelihood score of which the mobile device or phone number has been compromised or used for fraud. In many embodiments, this verification can involve requesting information and/or verification, and or sanctions screening, from one or more third party services. For example, the one or more third party services can perform checking on first name, last name, address, email, and phone number, OFAC (Office of Foreign Assets Control) checking, etc. In many embodiments, the consumer can be asked, on the mobile device (e.g., 340 (FIG. 3)) through a text message or other message outside of the merchant's eCommerce interface, to confirm that the consumer authorizes proceeding with the transaction.

Next, method 500 can proceed to an activity 524 of determining whether the consumer KYC is validated (e.g., the consumer's identity is verified), based on the information obtained in activity 522. If the outcome of activity 524 is no, method 500 can proceed to activity 510 of sending the payment processing down the normal processing path. If the outcome of activity 524 is yes, method 500 can proceed to an activity 526 of performing email risk monitoring. Activity 526 can be similar to activity 410 (FIG. 4). For example, activity 526 can involve verifying the consumer's identity and/or assessing risks associated with the consumer based on the consumer's provided email address. In some embodiments, activity 410 can request information and/or verification from one or more third party services.

Next, method 500 can proceed to an activity 527 of determining whether the email is validated, based on the information obtained in activity 526. If the outcome of activity 527 is no, method 500 can proceed to activity 510 of sending the payment processing down the normal processing path. If the outcome of activity 527 is yes, method 500 can proceed to an activity 528 of sending an authorization message to the consumer, such as an SMS (Short Messaging Service) message to the mobile phone (e.g., consumer device 340 (FIG. 3)) of the consumer (e.g., 341 (FIG. 3)). The authorization message can ask the consumer whether the consumer authorizes the transaction. In some cases, the consumer can be requested to click on a link if the consumer authorizes the transaction. In other cases, the consumer can be requested to respond (e.g., respond “Y” or “Yes”) if the consumer authorizes the transaction.

Next, method 500 can proceed to an activity 529 of determining whether the consumer authorized the transaction, based on the information obtained in activity 528. If the outcome of activity 529 is no, method 500 can proceed to activity 510 of sending the payment processing down the normal processing path. If the outcome of activity 529 is yes, method 500 can proceed to an activity 530 of detokenizing. In many embodiments, detokenizing can involve obtaining the card information, PII, and/or other information used in the subsequent activities (e.g., 531, 536) to process the payment. In some embodiments, the detokenization can involve requesting the information using the tokens from one or more third party services.

Next, method 500 can proceed to an activity 531 of creating a consumer subledger account and performing a debit pull. The consumer subledger account can be similar or identical to a consumer subledger 631 (FIG. 6), as described below in further detail. Once the consumer subledger account is created, the consumer can be setup to make payments using the card through payment system 300 (FIG. 3).

Jumping ahead in the drawings, FIG. 6 illustrates a block diagram showing payment rails 600 for payment processing using payment system 300 (FIG. 3), which can be employed for fraud elimination in payment processing, according to an embodiment. Payment rails 600 is merely exemplary, and embodiments of the system are not limited to the embodiments presented herein. The payment rails can be employed in many different embodiments or examples not specifically depicted or described herein.

As shown in FIG. 6, a partner financial institution FBO (For Benefit Of) account 630 can be used for processing the payments handled by payment system 300 (FIG. 3). FBO account 630 can be a FBO account at partner financial institution 360 (FIG. 3). An FBO account can be used to reduce the friction involved with processing payments, by not needing to create an individual demand deposit account (DDA) for each consumer (e.g., 341 (FIG. 3)). As part of activity 531 (FIG. 5A), a “me-to-me” debit pull can be performed from a consumer account 611, such as a credit card or debit card account at consumer financial institution 370 (FIG. 3), for the amount of the transaction associated with the consumer payment request (e.g., in activity 502 (FIG. 5A)), to move the funds to consumer subledger 631 in FBO account 630. Payment system 300 (FIG. 3) can track internal subledgers within FBO account 630. The debit pull from consumer account 611 to consumer subledger 631 can be performed such as by using an interbank transfer 640, such as an AFT (Account Funding Transaction).

If the me-to-me debit pull fails, then, returning to FIG. 5A, method 500 can proceed from activity 531 to activity 510 of sending the payment processing down the normal processing path. If the debit pull in activity 531 is successful, method 500 can proceed to an activity 532 of sending authorization to the client (e.g., eCommerce integration client 353 (FIG. 3)) to proceed with the transaction, and an activity 534 of performing intrabank subledger transfers. The client can receive the approval for the transaction in activity 532, as the funds for the payment have been successfully pulled from the consumer account (e.g., 611 (FIG. 6)). This approval in activity 532 can occur in an instant after the consumer requested payment and/or after activity 502.

Activity 534 can be performed as shown in FIG. 6. Jumping ahead again to FIG. 6, payment system 300 (FIG. 3) can perform and track intrabank transfers between subledgers. Specifically, activity 534 (FIG. 5A) can include an intrabank transfer 641 from consumer subledger 631 to merchant subledger 632. Additionally, there can be fees and/or revenue share payouts that are deducted from the payment to the merchant. For example, activity 534 (FIG. 5A) can include an intrabank transfer 648 from merchant subledger 632 to a payment system fees subledger 633, for processing fees, and, in some cases, an intrabank transfer 649 from payment system fees subledger 633 to a client subledger 634, for a revenue share payout. In many embodiments, the intrabank transfers do not involve movement of money from one bank account to another bank account, but instead involve payment system updating the relevant subledgers (e.g., consumer subledger 631, merchant subledger 632, payment system fees subledger 633, and/or client subledger 634).

In other embodiments, FBO account 630 can be split into two FBO accounts, a first FBO account for consumers, and a second FBO account for merchants. The first FBO account for consumers can include consumer subledgers (e.g., 631) for the consumers and/or the second FBO account for merchants can include merchant subledgers (e.g., 632) for the merchants. In such embodiments, transfer 641 can be a transfer between different FBO account, which can be at the same or different banks.

In yet other embodiments, there can be a first FBO account for consumers, and a respective DDA account for each individual merchant. The FBO account for consumers can include consumer subledgers (e.g., 631) for individual consumers and/or the respective DDA account for each individual merchant can be similar to each merchant subledger (e.g., 632) for individual merchants. In such embodiments, transfer 641 can be a transfer between the FBO account and the DDA account.

Returning to FIG. 5A, after performing the intrabank subledger transfers in activity 534, method 500 can proceed to an activity 536 of performing settlement. In many embodiments, activity 536 can include one or more interbank transfers from FBO account 630 to one or more other financial institutions. For example, as shown in FIG. 6, (i) an interbank transfer 642 can be made from merchant subledger 632 of FBO account 630 to a merchant external bank account 622 (e.g., a merchant account held by merchant 351 (FIG. 3) at merchant financial institution 380 (FIG. 3)), (ii) an interbank transfer 646 can be made from payment system fees subledger 633 of FBO account 630 to a payment system external bank account 623 (e.g., an account held by the entity operating payment system 300 (FIG. 3) at a financial institution), and/or (iii) an interbank transfer 647 can be made from client subledger 634 of FBO account 630 to a client external bank account 624 (e.g., an account held by eCommerce integration client 353 (FIG. 3) at a financial institution). In some embodiments, interbank transfer 642, 646, and/or 647 can be an OCT (Original Credit Transaction), a me-to-me push to card, an RTP (Real-Time Payment) provided by The Clearing House, a FedNow payment, or another suitable payment. In some embodiments, such interbank transfers can occur in a batch (e.g., a nightly sweep), or can occur in an instant.

In some embodiments, refunds from the merchant to the consumer can be processed through an interbank transfer 643 (e.g., AFT, RTP, FedNow, etc.) from merchant external bank account 622 to merchant subledger of FBO account 630, then an intrabank transfer 644 from merchant subledger 632 to consumer subledger 631, then an interbank transfer 645 (e.g., OCT) from consumer subledger 631 of FBO account 630 to consumer account 611. In some embodiments, the AFTs and/or OCTs (e.g., 640, 642, 643, 645, 646, 647) can be requested through VISA Direct using an API provided by a third party service.

Turning to FIG. 5B, activity 508 of existing user processing can include an activity 540 of performing current consumer KYC and ownership validation. The current consumer KYC and ownership validation can be similar to activity 522 (FIG. 5A) and/or activity 518 (FIG. 5A), but can involve a current verification of the consumer's identity and current ownership of the card, with a risk assessment. In many embodiments, the current ownership of the card can be determined similar to activity 518 (FIG. 5A). In many embodiments, the current consumer KYC and ownership verification can actively authenticate a mobile device of the consumer. For example, the mobile device authentication can verify ownership and possession of the mobile device and phone number, and a likelihood score of which the mobile device or phone number has been compromised or used for fraud. In many embodiments, this verification can involve requesting information and/or verification from one or more third party services. In many embodiments, the consumer can be asked, on the mobile device (e.g., 340 (FIG. 3)) through a text message or other message outside of the merchant's eCommerce interface, to confirm that the consumer authorizes proceeding with the transaction.

Next, activity 508 can proceed to an activity 542 of determining whether the current consumer KYC is validated (e.g., the consumer's identity is verified), based on the information obtained in activity 540. If the outcome of activity 542 is no, activity 508 can proceed to an activity 544 of sending the payment processing down the normal processing path, which can be similar or identical to activity 510 (FIG. 5A). If the outcome of activity 542 is yes, activity 508 can proceed to an activity 546 of creating a consumer subledger account and performing a debit pull. In some embodiments, the consumer subledger was already created, and is not re-created, but in other embodiments, the consumer subledger is recreated for each payment. The consumer subledger account can be similar or identical to a consumer subledger 631 (FIG. 6). The debit pull in activity 546 can be similar or identical to the debit pull in activity 531 (FIG. 5A), as described above. In many embodiments, a detokenization process (e.g., 530 (FIG. 5A)) can be performed before performing activity 546.

If the me-to-me debit pull fails, then activity 508 can proceed from activity 546 to activity 544 of sending the payment processing down the normal processing path. If the debit pull in activity 546 is successful, activity 508 can proceed to an activity 548 of sending authorization to the client (e.g., eCommerce integration client 353 (FIG. 3)) to proceed with the transaction, and an activity 550 of performing intrabank subledger transfers. Activity 548 can be similar or identical to activity 532 (FIG. 5A). Activity 550 can be similar or identical to activity 534 (FIG. 5A), but in many embodiments, there is no revenue share payout to the client (e.g., intrabank transfer 649 (FIG. 6)) in activity 550 of interbank subledger transfers for the existing user processing of activity 508.

After performing the intrabank subledger transfers in activity 550, activity 508 can proceed to an activity 552 of performing settlement. In many embodiments, activity 552 can be similar or identical to activity 536 (FIG. 5B), but in many embodiments, there is no interbank transfer 647 (FIG. 6) from client subledger 634 to client external bank account 624 (FIG. 6).

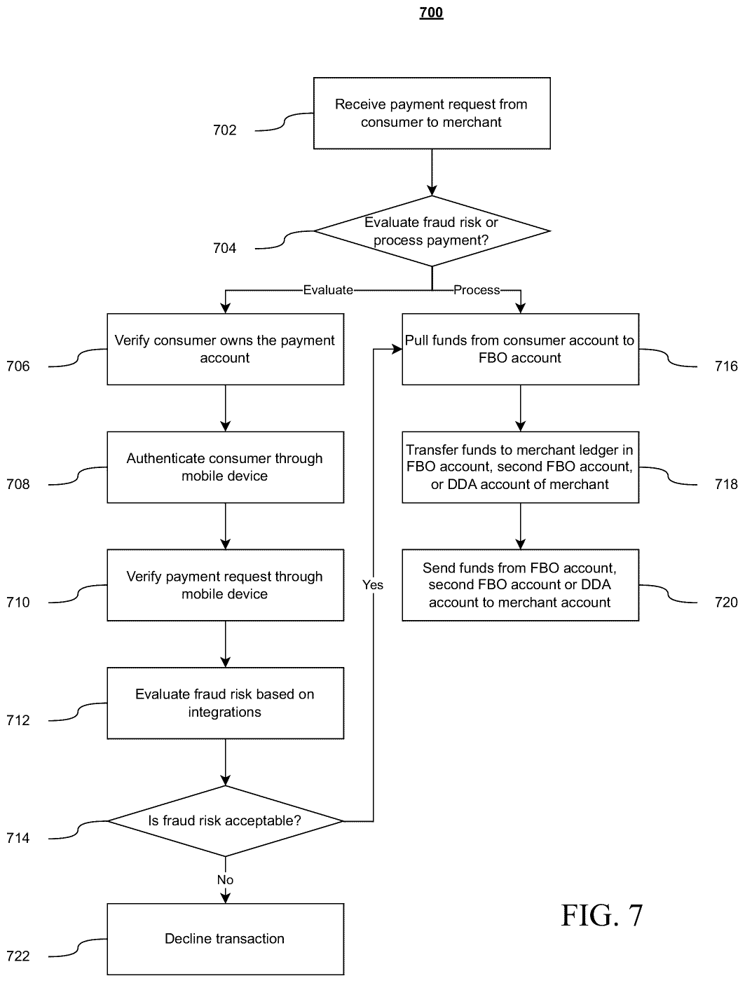

Turning ahead in the drawings, FIG. 7 illustrates a flow chart for a method 700 of payment processing, according to an embodiment. Method 700 is merely exemplary and is not limited to the embodiments presented herein. Method 700 can be employed in many different embodiments or examples not specifically depicted or described herein. In some embodiments, the procedures, the processes, and/or the activities of method 700 can be performed in the order presented. In other embodiments, the procedures, the processes, and/or the activities of method 700 can be performed in any suitable order. In still other embodiments, one or more of the procedures, the processes, and/or the activities of method 700 can be combined or skipped.

Method 700 can include an activity 702 of receiving a payment request for a payment transaction from a consumer to a merchant using a payment account of the consumer. Activity 702 can be similar or identical to activity 502 (FIG. 5A). Next, in some embodiments, method 700 can proceed to a decision point 704 to determine whether to evaluate fraud risk or proceed with processing the payment. If the outcome of decision point 704 is to evaluate fraud risk, method 700 can proceed through various activities, such as activities 706-714, described below.

Activity 706 can include verifying that the consumer owns the payment account. Activity 706 can be similar or identical to activity 518 (FIG. 5A) and/or activity 540 (FIG. 5B). In some embodiments, activity 706 can include verifying at least one of a name, an address, or a card verification value of a card associated with the payment account. In some embodiments, activity 706 can include performing account verification using a zero-dollar authorization.

Activity 708 can include authenticating the consumer through a mobile device of the consumer. Activity 708 can be similar or identical to activity 522 (FIG. 5A) and/or activity 540 (FIG. 5B). In some embodiments, activity 708 can include verifying ownership and possession of the mobile device and a phone number associated with the mobile device. In some embodiments, activity 708 can include determining a likelihood score that the mobile device or the phone number has been compromised or used for fraud.

Activity 710 can include verifying the payment request through the mobile device of the consumer. Activity 710 can be similar or identical to activity 528 (FIG. 5A). In some embodiments, activity 710 can include sending a message to the mobile device requesting confirmation of authorization for the payment transaction.

Activity 712 can include evaluating fraud risk for the payment transaction based on an integration of the verification that the consumer owns the payment account (such as performed in activity 706), and the authentication of the consumer and the verification of the payment request through a mobile device of the consumer (such as performed in activities 708-710). In some embodiments, activity 712 can include performing email risk monitoring to assess risks associated with the consumer based on an email address of the consumer. Activity 712 then evaluates fraud risk based on integrations.

After these verification activities, method 700 reaches a decision point 714 to determine if the fraud risk is acceptable. If the risk is not acceptable (No branch), method 700 proceeds to an activity 722, in which the transaction is declined. If the risk is acceptable (Yes branch), method 700 proceeds to the payment processing activities.

If the outcome of decision point 704 is to process the payment, or if the fraud risk is determined to be acceptable at decision point 714, method 700 can perform fund transfer activities, such as activities 716-720.

Activity 716 can include pulling funds from the payment account to the FBO account. Activity 716 can be similar or identical to interbank transfer 640 (FIG. 6).

Activity 718 can include transferring funds from a consumer ledger of the FBO account to a merchant ledger of the FBO account. Activity 718 can be similar or identical to intrabank transfer 641 (FIG. 6). Alternatively, activity 718 can include sending funds from the FBO account for consumers to a second FBO account for merchants or sending funds from the FBO account to a DDA account for the merchant.

Activity 720 can include sending funds from the merchant ledger of the FBO account to a merchant account of the merchant. Activity 720 can be similar or identical to interbank transfer 642 (FIG. 6). Alternatively, activity 720 can include sending funds from the second FBO account to a merchant account of the merchant or sending funds from the DDA account for the merchant to a merchant account of the merchant. In some embodiments, activity 720 can include performing an original credit transaction. In some embodiments, activity 720 can include performing an original credit transaction, performing a real-time payment, performing a FedNow payment, and/or another suitable sending of funds.

In some embodiments, method 700 can further include transferring funds from the merchant ledger to a payment system fees ledger of the FBO account for processing fees, which can be similar or identical to intrabank transfer 648 (FIG. 6). This transfer can occur after the funds are moved to the merchant ledger in activity 718.

In some embodiments, method 700 can include transferring funds from the payment system fees ledger to a client ledger of the FBO account for a revenue share payout, which can be similar or identical to intrabank transfer 649 (FIG. 6). This transfer can take place after the processing fees are moved to the payment system fees ledger. Following this transfer, funds can be sent from the client ledger to a client external bank account, which can be similar or identical to interbank transfer 647 (FIG. 6).

Method 700 can also accommodate refund processing. For example, method 700 can include receiving a refund request from the merchant, transferring funds from the merchant account to the merchant ledger of the FBO account, transferring funds from the merchant ledger to the consumer ledger of the FBO account, and sending funds from the consumer ledger of the FBO account to the payment account, which can be similar or identical to activities 643-645 (FIG. 6), respectively.

To enhance security, method 700 can involve tokenizing sensitive information associated with the consumer, which can be similar or identical to activity 512 (FIG. 5A). This sensitive information can include card information of a card associated with the payment account or personal identifiable information of the consumer. After tokenization, a user record for the consumer can be created using the tokenized sensitive information, which can be similar or identical to activity 514 (FIG. 5A). Before pulling funds from the consumer account in activity 716, the tokenized sensitive information can be detokenized, which can be similar or identical to activity 530 (FIG. 5A).

Additionally, method 700 can include determining whether the consumer is a new user or an existing user for the payment transaction. Based on this determination, a different verification process can be performed, tailoring the fraud risk evaluation to the user's history with the system. For example, processing for new users can be similar or identical to activities 512-536 (FIG. 5A). Processing for existing users can be similar or identical to activities 540-552 (FIG. 5B).

In many embodiments, the techniques described herein can provide a practical application and several technological improvements. For example, the consumer (e.g., 341 (FIG. 3)) can continue to use its existing payment account(s) or card(s) associated therewith (e.g., credit card, debit card, DDA, FBO, digital wallet, etc.) at its existing bank(s) (e.g., consumer financial institution 370 (FIG. 3)), and the merchant (e.g., 351 (FIG. 3)) can continue to use its existing bank account at its existing bank (e.g., merchant financial institution 380 (FIG. 3)) to process payments without the complexity of conventional systems. The arrangement of the connections and the elimination of multiple processing entities and card network(s) significantly improves the processing approach. These techniques also involve significant fraud risk assessment to reduce and/or eliminate the fraud and chargebacks involved in conventional approaches. Further, these techniques reduce the fees involved in conventional card networks that are used, in part, to cover fraud risks. Additionally, these techniques can result in instant money transfer, such that the merchant has instant settlement and availability of funds from the payment, and the merchant is indemnified against fraud.

Although the methods described above are with reference to the illustrated flowcharts, it will be appreciated that many other ways of performing the acts associated with the methods can be used. For example, the order of some operations may be changed, and some of the operations described may be optional.

In addition, the methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

The foregoing is provided for purposes of illustrating, explaining, and describing embodiments of these disclosures. Modifications and adaptations to these embodiments will be apparent to those skilled in the art and may be made without departing from the scope or spirit of these disclosures.

Although fraud elimination in instant payment processing has been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-7 may be modified, and that the foregoing discussion of certain of these embodiments does not necessarily represent a complete description of all possible embodiments. For example, one or more of the procedures, processes, or activities of FIGS. 4-7 may include different procedures, processes, and/or activities and be performed by many different modules, in many different orders, and/or one or more of the procedures, processes, or activities of FIGS. 4-7 may include one or more of the procedures, processes, or activities of another different one of FIGS. 4-7. As another example, the systems and/or engines within payment system 300 (FIG. 3) can be interchanged or otherwise modified.

Replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A computer-implemented method comprising:
receiving a payment request for a payment transaction from a consumer to a merchant using a payment account of the consumer; and
at least one of:
evaluating fraud risk for the payment transaction based on an integration of (i) a verification that the consumer owns the payment account, and (ii) an authentication of the consumer and a verification of the payment request through a mobile device of the consumer; or
processing the payment transaction using an FBO account to make funds from the payment transaction available to the merchant in an instant, comprising:
pulling funds from the payment account to the FBO account; and
one of:
(i)
transferring funds from a consumer ledger of the FBO account to a merchant ledger of the FBO account; and
sending funds from the merchant ledger of the FBO account to a merchant account of the merchant;
(ii)
sending funds from the FBO account for consumers to a second FBO account for merchants; and
sending funds from the second FBO account to a merchant account of the merchant; or
(iii)
sending funds from the FBO account to a DDA account for the merchant; and
sending funds from the DDA account for the merchant to a merchant account of the merchant.

2. The computer-implemented method of claim 1, comprising evaluating the fraud risk for the payment transaction, wherein the verification that the consumer owns the payment account comprises:
verifying at least one of a name, an address, or a card verification value of a card associated with the payment account.

3. The computer-implemented method of claim 1, comprising evaluating the fraud risk for the payment transaction, wherein the verification that the consumer owns the payment account comprises:
performing account verification using a zero-dollar authorization.

4. The computer-implemented method of claim 1, comprising evaluating the fraud risk for the payment transaction, wherein the authentication of the consumer through the mobile device of the consumer comprises:
verifying ownership and possession of the mobile device and a phone number associated with the mobile device.

5. The computer-implemented method of claim 4, wherein the authentication of the consumer through the mobile device of the consumer further comprises:
determining a likelihood score that the mobile device or the phone number has been compromised or used for fraud.

6. The computer-implemented method of claim 1, comprising evaluating the fraud risk for the payment transaction, wherein the verification of the payment request through the mobile device of the consumer comprises:
sending a message to the mobile device requesting confirmation of authorization for the payment transaction.

7. The computer-implemented method of claim 1, comprising evaluating the fraud risk for the payment transaction, further comprising:
performing email risk monitoring to assess risks associated with the consumer based on an email address of the consumer.

8. The computer-implemented method of claim 1, comprising processing the payment transaction using the FBO account, wherein sending funds to the merchant account of the merchant comprises:
performing an original credit transaction.

9. The computer-implemented method of claim 1, comprising processing the payment transaction using the FBO account, wherein sending funds to the merchant account of the merchant comprises:
performing a real-time payment.

10. The computer-implemented method of claim 1, comprising processing the payment transaction using the FBO account, wherein sending funds to the merchant account of the merchant comprises:
performing a FedNow payment.

11. The computer-implemented method of claim 1, comprising processing the payment transaction using the FBO account, further comprising:
transferring funds from the merchant ledger to a payment system fees ledger of the FBO account for processing fees.

12. The computer-implemented method of claim 11, further comprising:
transferring funds from the payment system fees ledger to a client ledger of the FBO account for a revenue share payout.

13. The computer-implemented method of claim 12, further comprising:
sending funds from the client ledger to a client external bank account.

14. The computer-implemented method of claim 1, further comprising:
receiving a refund request from the merchant;
transferring funds from the merchant account to the merchant ledger of the FBO account;
transferring funds from the merchant ledger to the consumer ledger of the FBO account; and
sending funds from the consumer ledger of the FBO account to the payment account.

15. The computer-implemented method of claim 1, further comprising:
tokenizing sensitive information associated with the consumer, wherein the sensitive information comprises at least one of card information of a card associated with the payment account or personal identifiable information of the consumer.

16. The computer-implemented method of claim 15, further comprising:
creating a user record for the consumer using the tokenized sensitive information.

17. The computer-implemented method of claim 16, further comprising:
detokenizing the tokenized sensitive information before pulling funds from the payment account.

18. The computer-implemented method of claim 1, further comprising:
determining whether the consumer is a new user or an existing user for the payment transaction; and
performing a different verification process based on whether the consumer is the new user or the existing user.

19. A system comprising one or more processors and one or more non-transitory computer-readable media storing computing instructions that, when executed on the one or more processors, cause the one or more processors to perform operations comprising:
receiving a payment request for a payment transaction from a consumer to a merchant using a payment account of the consumer; and
at least one of:
evaluating fraud risk for the payment transaction based on an integration of (i) a verification that the consumer owns the payment account, and (ii) an authentication of the consumer and a verification of the payment request through a mobile device of the consumer; or
processing the payment transaction using an FBO account to make funds from the payment transaction available to the merchant in an instant, comprising:
pulling funds from the payment account to the FBO account; and one of:
(i)
transferring funds from a consumer ledger of the FBO account to a merchant ledger of the FBO account; and
sending funds from the merchant ledger of the FBO account to a merchant account of the merchant;
(ii)
sending funds from the FBO account for consumers to a second FBO account for merchants; and
sending funds from the second FBO account to a merchant account of the merchant; or
(iii)
sending funds from the FBO account to a DDA account for the merchant; and
sending funds from the DDA account for the merchant to a merchant account of the merchant.

20. One or more non-transitory computer-readable media comprising computing instructions that, when executed on one or more processors, cause one or more processors to perform operations comprising:
receiving a payment request for a payment transaction from a consumer to a merchant using a payment account of the consumer; and
at least one of:
evaluating fraud risk for the payment transaction based on an integration of (i) a verification that the consumer owns the payment account, and (ii) an authentication of the consumer and a verification of the payment request through a mobile device of the consumer; or
processing the payment transaction using an FBO account to make funds from the payment transaction available to the merchant in an instant, comprising:
pulling funds from the payment account to the FBO account; and one of:
(i)
transferring funds from a consumer ledger of the FBO account to a merchant ledger of the FBO account; and
sending funds from the merchant ledger of the FBO account to a merchant account of the merchant;
(ii)
sending funds from the FBO account for consumers to a second FBO account for merchants; and
sending funds from the second FBO account to a merchant account of the merchant; or
(iii)
sending funds from the FBO account to a DDA account for the merchant; and
sending funds from the DDA account for the merchant to a merchant account of the merchant.
